(19) United States
(12) Patent Application Publication
(10) Pub. No.: US 2021/0154066 A1
(43) Pub. Date: May 27, 2021

(54) Electric Bed with a Lifting Adjustment Structure

(71) Applicant: APEX HEALTH CARE MFG. INC., Minxiong Township (TW)

(72) Inventor: Chi-Chung Huang, Minxiong Township (TW)

(21) Appl. No.: 16/690,255

(22) Filed: Nov. 21, 2019

(51) Int. Cl. A61G 7/018; A61G 7/005

(52) U.S. Cl. CPC A61G 7/018; A61G 7/005

(57) ABSTRACT

An electric bed includes a bed frame (23), a power device (20), a linkage (21), and a control device (22). The bed frame includes a head portion (230) and a leg portion (231). The power device includes a first electric cylinder (200), and a second electric cylinder (201). The first electric cylinder is mounted on the head portion of the bed frame, and the second electric cylinder is mounted on the leg portion of the bed frame. The first electric cylinder drives the head portion of the bed frame, and the second electric cylinder drives the leg portion of the bed frame. The first electric cylinder and the second electric cylinder cooperate to control an inclined angle of the electric bed, and to lift or lower the electric bed horizontally.

### BACKGROUND OF THE INVENTION

### 1. Field of the Invention

The present invention relates to a bed and, more particularly, to an electric bed.

### 2. Description of the Related Art

A conventional lifting electric bed 1 in accordance with the prior art shown in FIG. 1 comprises a bed frame 10 and a stand 11. The bed frame 10 includes a plurality of links 100. The stand 11 includes an electric cylinder 110 having a push rod 1100. In operation, the push rod 1100 of the electric cylinder 110 is moved to move the links 100 of the bed frame 10, to control the bed frame 10, such that the conventional electric bed 1 is lifted or lowered. However, the links 100 and the electric cylinder 110 are mounted on the middle of the conventional electric bed 1, such that the conventional electric bed 1 is lifted or lowered only, and cannot adjust its inclined angle, thereby limiting the versatility of the conventional electric bed 1.

### BRIEF SUMMARY OF THE INVENTION

The primary objective of the present invention is to provide an electric bed with a lifting adjustment structure.

In accordance with the present invention, there is provided an electric bed comprising a bed frame, a power device, a linkage, and a control device. The bed frame includes a head portion and a leg portion. The power device includes a first electric cylinder, and a second electric cylinder. The first electric cylinder is mounted on the head portion of the bed frame, and the second electric cylinder is mounted on the leg portion of the bed frame. The linkage includes a plurality of support links to support the bed frame. The control device includes a plurality of electric cords electrically connected with the first electric cylinder, and the second electric cylinder. The first electric cylinder drives the head portion of the bed frame, and the second electric cylinder drives the leg portion of the bed frame. The first electric cylinder and the second electric cylinder cooperate to control an inclined angle of the electric bed, and to lift or lower the electric bed horizontally.

According to the primary advantage of the present invention, the head portion and the leg portion of the bed frame are lifted or lowered freely.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional electric bed in accordance with the prior art.

FIG. 2 is an exploded perspective view of an electric bed in accordance with the preferred embodiment of the present invention.

FIG. 3 is a perspective view of the electric bed in accordance with the preferred embodiment of the present invention.

FIG. 4 is a schematic view showing head lifting of the electric bed in accordance with the preferred embodiment of the present invention.

FIG. 5 is a schematic view showing head lifting of the electric bed in accordance with the preferred embodiment of the present invention.

FIG. 6 is a schematic view showing simultaneous lifting of the electric bed in accordance with the preferred embodiment of the present invention.

FIG. 7 is a schematic view showing another adjustment of the electric bed in accordance with the preferred embodiment of the present invention.

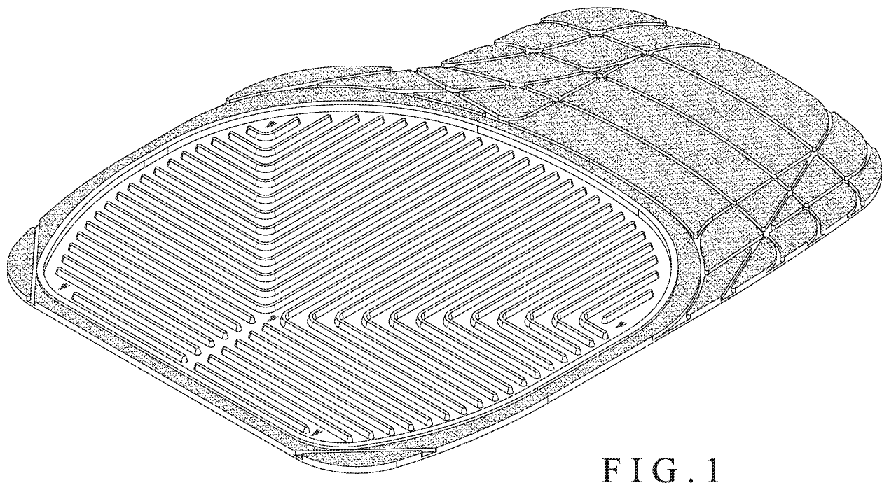

### DETAILED DESCRIPTION OF THE INVENTION

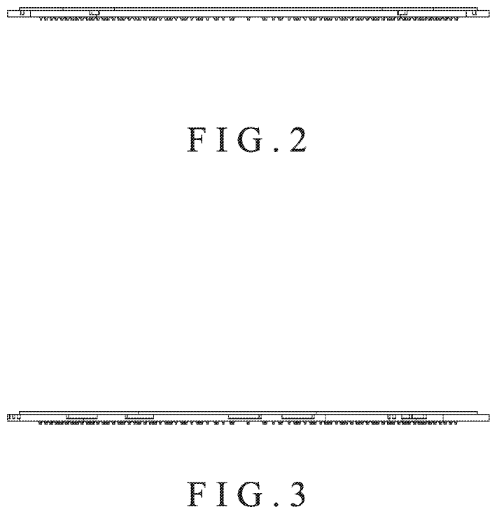

Referring to FIGS. 2-7, an electric bed 2 in accordance with the preferred embodiment of the present invention comprises a bed frame 23, a bottom board 24, at least one bed board 25, a power device 20, a linkage 21, and a control device 22.

The bed frame 23 includes a head portion 230 and a leg portion 231.

The power device 20 includes a first electric cylinder 200, a second electric cylinder 201, a third electric cylinder 202, and a fourth electric cylinder 203.

The first electric cylinder 200 is mounted on the head portion 230 of the bed frame 23, and the second electric cylinder 201 is mounted on the leg portion 231 of the bed frame 23. Thus, the first electric cylinder 200 and the second electric cylinder 201 cooperate to control an inclined angle of the bed frame 23.

The third electric cylinder 202 and the fourth electric cylinder 203 are mounted on a central position of the bottom board 24, and are connected with the at least one bed board 25, to control and lift the at least one bed board 25.

The first electric cylinder 200 has a telescopically arranged push rod 2000 connected with the head portion 230 of the bed frame 23, to drive the head portion 230 of the bed frame 23. The second electric cylinder 201 has a telescopically arranged push rod 2010 connected with the leg portion 231 of the bed frame 23, to drive the leg portion 231 of the bed frame 23. The third electric cylinder 202 has a telescopically arranged push rod 2020 connected with a head support board 240 of the bed frame 23, to drive the head support board 240 of the bed frame 23. The fourth electric cylinder 203 has a telescopically arranged push rod 2030 connected with a waist support board of the bed frame 23, to drive the waist support board of the bed frame 23.

The linkage 21 includes a plurality of support links 210 connected with the bed frame 23, to support the bed frame 23.

The control device 22 includes a plurality of electric cords 220 electrically connected with the first electric cylinder 200, the second electric cylinder 201, the third electric cylinder 202, and the fourth electric cylinder 203, to control operation of the first electric cylinder 200, the second electric cylinder 201, the third electric cylinder 202, and the fourth electric cylinder 203.

In the preferred embodiment of the present invention, the electric bed 2 comprises two bed boards 25 located at a central position of the bed frame 23. The two bed boards 25 are driven by the third electric cylinder 202 and the fourth electric cylinder 203.

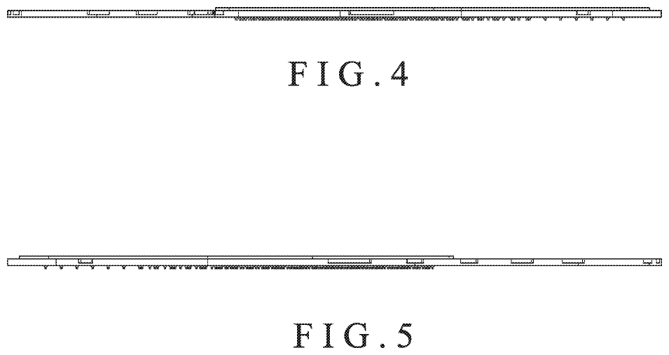

In operation, referring to FIG. 4 with reference to FIGS. 2 and 3, the control device 22 drives and controls the first electric cylinder 200 of the power device 20, such that the push rod 2000 of the first electric cylinder 200 pushes the head portion 230 of the bed frame 23 upward. In such a manner, the head portion 230 of the bed frame 23 is inclined relative to the leg portion 231 of the bed frame 23, such that the bed frame 23 of the electric bed 2 forms an inclined angle.

Alternatively, referring to FIG. 5 with reference to FIGS. 2 and 3, the third electric cylinder 202 pushes and lifts the head support board 240 of the bed frame 23. Then, the control device 22 drives and controls the first electric cylinder 200 of the power device 20, such that the push rod 2000 of the first electric cylinder 200 pushes the head portion 230 of the bed frame 23 upward. In such a manner, the head portion 230 of the bed frame 23 is inclined relative to the leg portion 231 of the bed frame 23, such that the bed frame 23 of the electric bed 2 forms an inclined angle.

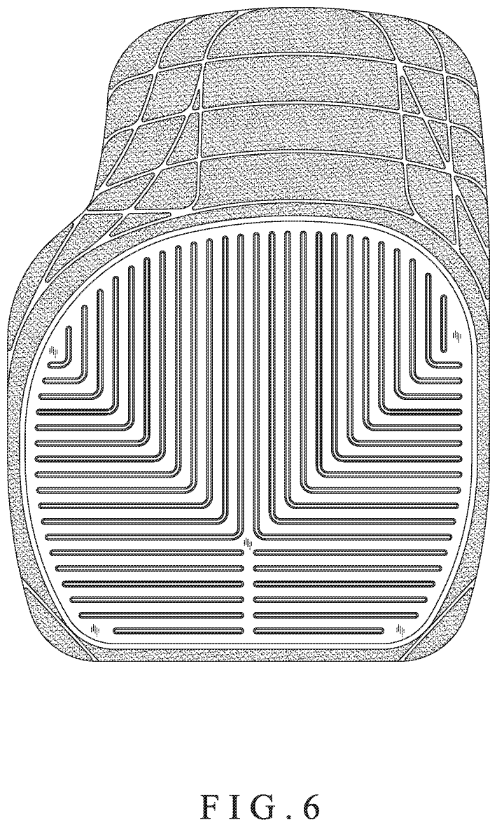

Alternatively, referring to FIG. 6 with reference to FIGS. 2 and 3, the control device 22 drives and controls the first electric cylinder 200 and the second electric cylinder 201 of the power device 20, such that the head portion 230 and the leg portion 231 of the bed frame 23 are lifted or lowered simultaneously.

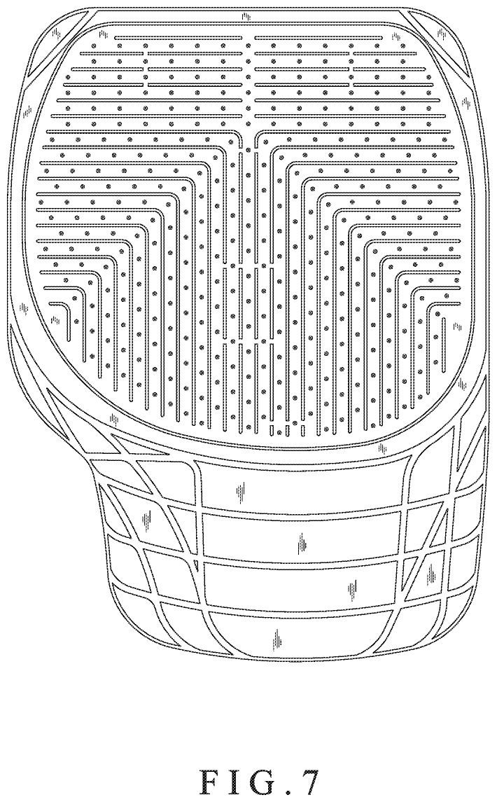

Alternatively, referring to FIG. 7 with reference to FIGS. 2 and 3, the control device 22 drives and controls the first electric cylinder 200 and the second electric cylinder 201 of the power device 20, such that the head portion 230 and the leg portion 231 of the bed frame 23 are lifted simultaneously. Then, the control device 22 drives and controls the second electric cylinder 201 of the power device 20, such that the leg portion 231 of the bed frame 23 is lowered individually.

Accordingly, the control device 22 drives and controls the first electric cylinder 200 of the power device 20, such that the head portion 230 of the bed frame 23 forms an inclined angle. In addition, the control device 22 drives and controls the first electric cylinder 200 and the second electric cylinder 201 of the power device 20, such that the head portion 230 and the leg portion 231 of the bed frame 23 are lifted or lowered simultaneously. Further, the control device 22 drives and controls the first electric cylinder 200 and the second electric cylinder 201 of the power device 20, such that the head portion 230 and the leg portion 231 of the bed frame 23 are lifted simultaneously, and the control device 22 then drives and controls the second electric cylinder 201 of the power device 20, such that the leg portion 231 of the bed frame 23 is lowered individually. Further, the inclined angle of the electric bed 2 is adjusted freely by cooperation of the power device 20, the linkage 21, and the control device 22.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An electric bed comprising:
a bed frame, a power device, a linkage, and a control device;
wherein:
the bed frame includes a head portion and a leg portion;
the power device includes a first electric cylinder, and a second electric cylinder;
the first electric cylinder is mounted on the head portion of the bed frame, and the second electric cylinder is mounted on the leg portion of the bed frame;
the linkage includes a plurality of support links to support the bed frame;
the control device includes a plurality of electric cords electrically connected with the first electric cylinder, and the second electric cylinder;
the first electric cylinder drives the head portion of the bed frame, and the second electric cylinder drives the leg portion of the bed frame; and
the first electric cylinder and the second electric cylinder cooperate to control an inclined angle of the electric bed, and to lift or lower the electric bed horizontally.
